(19) United States
(12) Patent Application Publication
(10) Pub. No.: US 2024/0224129 A1
(43) Pub. Date: Jul. 4, 2024

(54) METHOD AND APPARATUS FOR SUPPORTING SOR-CMCI CONFIGURATION DURING CELL CHANGE IN A WIRELESS COMMUNICATION SYSTEM

(71) Applicant: Samsung Electronics Co., Ltd, Gyeonggi-do (KR)

(72) Inventors: Lalith KUMAR, Bangalore (IN); Danish Ehsan HASHMI, Bangalore (IN); Arijit SEN, Bangalore (IN); Koustav ROY, Bangalore (IN)

(21) Appl. No.: 18/554,313

(22) PCT Filed: Apr. 7, 2022
(86) PCT No.: PCT/KR2022/005057

§ 371 Date: Oct. 6, 2023

(30) Foreign Application Priority Data
Apr. 8, 2021 (IN) 202141016632
Mar. 21, 2022 (IN) 202141016632

(51) Int. Cl. H04W 36/00; H04W 36/14; H04W 60/06; H04W 84/04

(52) U.S. Cl. CPC H04W 36/00222; H04W 36/1443; H04W 60/06; H04W 84/042

(57) ABSTRACT

The disclosure relates to a 5G or 6G communication system for supporting a higher data transmission rate. According to various embodiments of the present disclosure, a method of operating a user equipment (UE) in a wireless communication system is provided. The method comprises: while the UE is connected to a first cell of a new generation radio access network (NG-RAN), receiving SOR-CMCI (steering of roaming connected mode control information) from the first cell; starting a Tsor-cm timer based on the SOR-CMCI; and in case a cell change of the UE from the first cell to a second cell is detected and the second cell is a cell of an access technology other than NG-RAN; stopping the Tsor-cm timer.

### TECHNICAL FIELD

The present disclosure relates generally to wireless communication systems and, more specifically, the present disclosure relates to method and apparatus for supporting SOR-CMCI configuration during cell change in a wireless communication system.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to wireless communication systems and, more specifically, the present disclosure relates to method and apparatus for supporting SOR-CMCI configuration during cell change in a wireless communication system.

### Solution to Problem

According to various embodiments of the present disclosure, a method of operating a user equipment (UE) in a wireless communication system is provided. The method comprises: while the UE is connected to a first cell of a new generation radio access network (NG-RAN), receiving SOR-CMCI (steering of roaming connected mode control information) from the first cell; starting a Tsor-cm timer based on the SOR-CMCI; and in case a cell change of the UE from the first cell to a second cell is detected and the second cell is a cell of an access technology other than NG-RAN: stopping the Tsor-cm timer.

According to various embodiments of the present disclosure, a user equipment (UE) in a wireless communication system is provided. The UE comprises: a transceiver; and at least one processor operably coupled to the transceiver, and configured to: while the UE is connected to a first cell of a new generation radio access network (NG-RAN), receive SOR-CMCI (steering of roaming connected mode control information) from the first cell; start a Tsor-cm timer based on the SOR-CMCI; and in case a cell change of the UE from the first cell to a second cell is detected and the second cell is a cell of an access technology other than NG-RAN: stop the Tsor-cm timer.

Other technical features may be readily apparent to one skilled in the art from the following figures, descriptions, and claims.

### Advantageous Effects of Invention

The present disclosure relates to wireless communication systems and, more specifically, the present disclosure relates to method and apparatus for supporting SOR-CMCI configuration during cell change in a wireless communication system.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 illustrates an example of a scenario for managing SoR-CMCI in a wireless communication system.

FIG. 2 illustrates an example of a scenario for managing SoR-CMCI in a wireless communication system.

FIG. 3 illustrates an example of a scenario for managing SoR-CMCI in a wireless communication system.

FIG. 4 illustrates an example of a network structure for processing SOR-CMCI configuration during handover in a wireless communication system according to various embodiments of the present disclosure.

FIG. 5 illustrates an example of a process for processing SOR-CMCI configuration during handover in a wireless communication system according to various embodiments of the present disclosure.

### BEST MODE FOR CARRYING OUT THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Embodiments herein disclose a method for handling SOR-CMCI configuration during a cell change of a UE (100). The method includes receiving the SOR-CMCI configuration or SOR information from a network apparatus (500) when the UE (100) is in a new generation radio access network (NG-RAN) cell which supports 5G communication. Further, the method includes initiating a Tsor-cm timer by applying the SOR-CMCI configuration. Further, the method includes detecting a cell change from a first cell to a second cell. Further, the method includes stop applying the SOR-CMCI configuration in response to determining that the UE performs the cell change from the first cell to the second cell, stopping the Tsor-em timer, wherein the first cell is a NG-RAN cell and the second cell is a legacy wireless network cell, and attempting to obtain service on a higher priority public land mobile network (PLMN) when the UE enters an idle mode or a 5G mobility management-connected (5GMM-CONNECTED) mode with radio resource control (RRC) inactive indication.

Embodiments disclosed herein relate to wireless communication networks, and more particularly related to a method and a User Equipment (UE) for handling SOR-CMCI configuration during a cell change of a UE by the UE in the wireless communication networks. This application is based on and derives the benefit of Indian Provisional Application 202141016632 filed on 8 Apr. 2021, the contents of which are incorporated herein by reference.

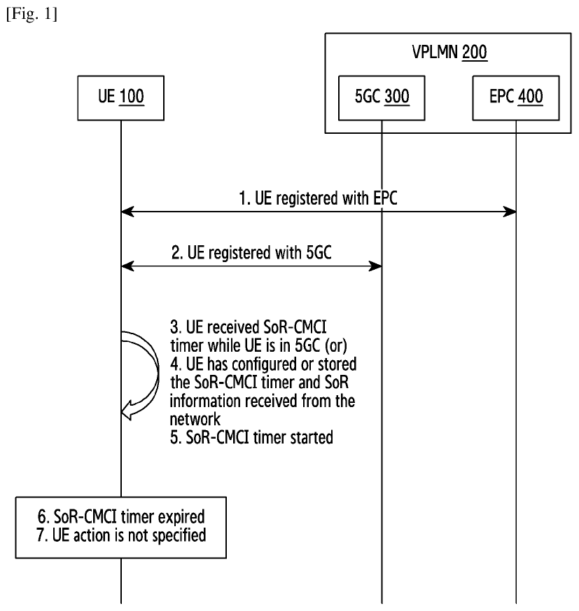

FIG. 1 to FIG. 3 depict example scenarios of issues with current solutions in managing SoR-CMCI in a wireless communication network, according to prior art.

FIG. 1 illustrates an example of a scenario for managing SoR-CMCI in a wireless communication system.

As shown in FIG. 1, consider that a UE (100) is dual registered. At step 1, the UE (100) is registered with an Evolved Packet Core (EPC) (400). At step 2, the UE (100) is registered with a fifth-generation core (5GC) (300). At step 3, the UE (100) receives a SoR-CMCI information from the 5GC (300). At step 4, the UE (100) has configured or stored SoR-CMCI timer and received SoR information from the network (either from the EPC (400) or the 5GC (300)). At step 5, the Tsor-cm timer has started. At step6, the SoR-CMCI (also called as Tsor-cm) timer has expired. At step 7, however, the handling of the SoR-CMCI timer, while the UE (100) is dual registered mode has not been specified.

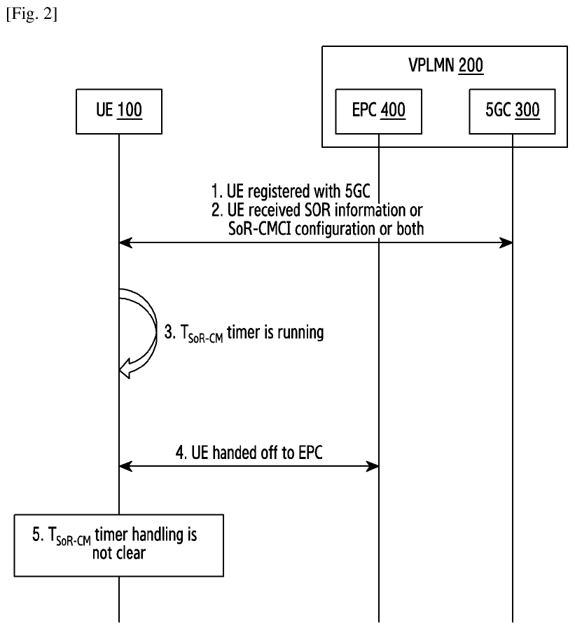

FIG. 2 illustrates an example of a scenario for managing SoR-CMCI in a wireless communication system.

As shown in FIG. 2, at step1, the UE (100) has registered on the 5GC (300) in a Visited Public Land Mobile Network (VPLMN) (200). At step 2, the UE (100) receives the SoR-CMCI configuration or the SOR information from the 5GC (300). At step 3, the UE (100) starts Tsor-cm timer while the SoR-CMCI timer is running. At step 4, the UE (100) performs intersystem or intrasystem change procedures like handed off (also called as handover procedure) to the EPC (400). At step 5, however, how to deal with already running Tsor-cm timer has not been addressed in current prior art.

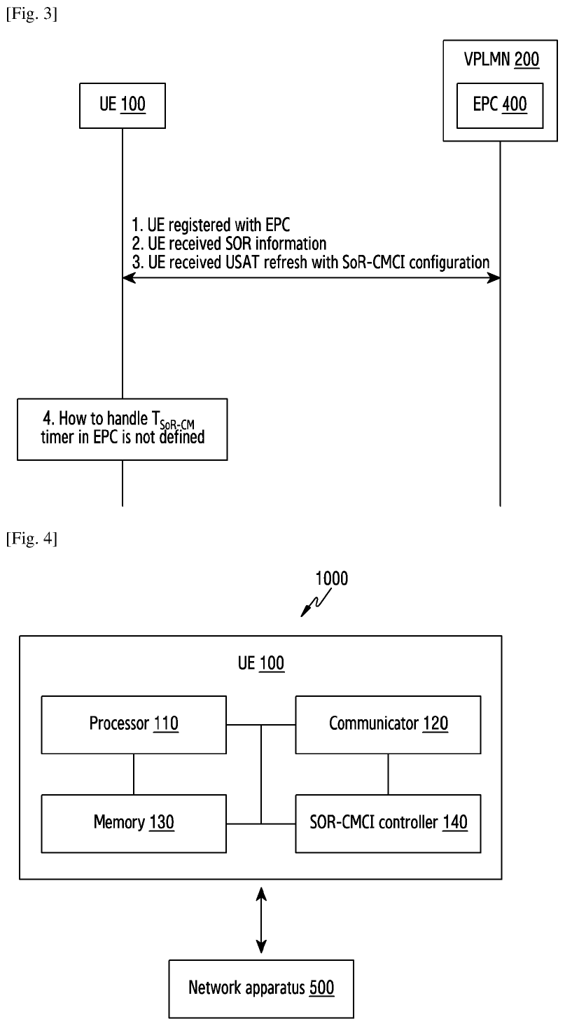

FIG. 3 illustrates an example of a scenario for managing SoR-CMCI in a wireless communication system.

As shown in FIG. 3, at step1, the UE (100) has attached on the EPC (400) in the VPLMN (200). At step 2, the UE (100) receives the SoR information from the EPC (400) and the SoR-CMCI timer via USAT refreshes (i.e., an indication from a universal subscriber identity module (USIM) to the UE (100)). At step 3, the UE (100) received USAT refresh with SoR-CMCI configuration. At step 4, however, how to deal with SoR-CMCI information (received in 5GS) in the EPC (400) has not been defined in current prior art.

Thus, it is desired to address the above-mentioned disadvantages or other shortcomings or at least provide a useful alternative.

The principal object of the embodiments herein is to provide a method and a UE for handling SOR-CMCI configuration during a cell change of a UE by the UE in a wireless communication network.

Another object of the embodiments herein is to manage SOR CMCI information when the UE is in different radio access technologies. The UE determines that the UE has received the steering of roaming (SOR) information or the SOR CMCI information. The SOR information is used by mobile operators to redirect their subscribers to preferred networks while the subscribers are roaming abroad. The UE determines that the UE has been configured with the SOR CMCI information, thus the UE starts Tsor-CM timers. In response to determining that the UE has moved to legacy RAT (e.g., EPC/3G network/2G network), the UE behaves as if no SOR_CMCI is configured (i.e., stop applying SOR_CMCI configuration), the UE stop all the running Tsor-CM timers. Further, the UE shall wait for NAS signaling connection release the UE shall wait until it moves to idle mode or 5GMM-CONNECTED mode with RRC inactive indication (refer 3GPP TS 24.501) before attempting to obtain service on a higher priority PLMN by acting as if timer T that controls periodic attempts has expired.

Another object of the embodiments herein is to provide the SOR CMCI information when the UE is in different radio access technologies. The UE determines that the UE has received the SOR or the SOR CMCI information. The UE determines that the UE has been configured with the SOR CMCI information, thus the UE starts Tsor-CM timers. In response to determining that UE is in the 5GS, the UE continue to run the Tsor-CM timer. At expiry of Tsor-CM timer, then the UE will execute a NAS procedure requesting the release of all PDU sessions and resources and move in IDLE mode. Further, the NAS procedure to request the release of all the PDU session and resources to move in an IDLE mode is triggered only if and has a list of available and allowable PLMNs in the area and based on this list or any other implementation specific means, the UE determines that there is a higher priority PLMN than the selected VPLMN.

Accordingly, the embodiments herein provide a method for handling steering of roaming connected mode control information (SOR-CMCI) configuration during a cell change of a UE. The method includes receiving, by the UE, the SOR-CMCI configuration or SOR information from a network apparatus when the UE is in a NG-RAN cell, also called as 5G system (5GS). Further, the method includes initiating, by the UE, a Tsor-cm timer by applying the SOR-CMCI configuration. Further, the method includes detecting, by the UE, a cell changes from a first cell to a second cell. Further, the method includes performing, by the UE, one of: stop applying the SOR-CMCI configuration in response to determining that the UE performs the cell change from the first cell to the second cell, stopping the Tsor-cm timer, wherein the first cell is a NG-RAN cell and the second cell is a legacy wireless network cell, and attempting to obtain service on a higher priority PLMN when the UE enters an idle mode or a 5GMM-CONNECTED mode with RRC inactive indication, and continue running the Tsor-cm timer, and on expiry of the Tsor-cm timer performing at least one Tsor-CM-timer expiry action in response to determining that the UE performs cell change from the first cell to the second cell, wherein the first cell is a NG-RAN cell and the second cell is a new NG-RAN cell.

In an embodiment, the cell change is due to at least one of a handover procedure, a redirection procedure, a cell change order and a reselection procedure, any procedure which facilitates UE to change the cell from first cell to second cell. The cell change can be intersystem change or intra system change between different systems like 2G, 3G, 4G, 5G or between the PLMN-IDs i.e., one PLMN ID to another PLMN ID.

Steering of Roaming information: This consists of the following HPLMN or subscribed SNPN protected information
a) the following indicators, of whether:
   the UDM requests an acknowledgement from the UE for successful reception of the steering of roaming information.
   the UDM requests the UE to store the SOR-CMCI in the ME, which is provided along with the SOR-CMCI in plain text; and
b) one of the following:
1) one or more of the following:
   list of preferred PLMN/access technology combinations with an indication that it is included;
   SOR-CMCI; or
   SOR-SNPN-SI;
2) a secured packet with an indication that it is included;
3) the HPLMN indication that ‘no change of the “Operator Controlled PLMN Selector with Access Technology” list stored in the UE is needed and thus no list of preferred PLMN/access technology combinations is provided’; or
4) the subscribed SNPN or HPLMN indication that ‘no change of the SOR-SNPN-SI stored in the UE is needed and thus no SOR-SNPN-SI is provided’, and SOR-CMCI, if any.

Steering of roaming connected mode control information (SOR-CMCI) is a HPLMN information to control the timing for a UE in connected mode to move to idle mode in order to perform steering of roaming. For example the HPLMN information can have a timer for a specific service i.e. if voice call is ongoing how long UE can remain in connected mode to complete the voice call after which UE will abort the service and perform steering of roaming procedure to avoid any delays in going to higher priority PLMN.

In an embodiment, the legacy wireless network cell is one of an UMTS Terrestrial Radio Access Network (UTRAN) cell also called as 3G network, an evolved UTRAN (E-UTRAN) cell also called as Evolved Packet System (EPS)/Evolved Packet Core (EPC) network or 4GS network, and a GSM EDGE Radio Access Network (GERAN) cell also called as 2G network.

In an embodiment, performing the at least one Tsor-CM-timer expiry action comprises determining, by the UE, to perform a PLMN selection, determining, by the UE, that the UE is in a connected state, performing, by the UE, a Non-access stratum (NAS) procedure comprising deregistration procedure requesting release of all Protocol Data Unit (PDU) sessions and services, determining, by the UE, that the UE enters in an IDLE mode; and attempting, by the UE, to obtain service on a higher priority PLMN by performing PLMN selection procedure.

In an embodiment, the PLMN selection is determined based on at least one of determining by the UE that there is a higher priority PLMN than selected VPLMN in response to determining that the list of available and the allowable PLMNs in the area is available at the UE and inability of the UE to determine a higher priority PLMN than selected VPLMN in response to determining that the list of available and the allowable PLMNs in the area is not available.

Accordingly, the embodiments herein provide a UE for handling SOR-CMCI configuration during an intersystem/intrasystem change for example handover procedure. The UE includes a SOR-CMCI controller communicatively coupled to a memory and a processor. The SOR-CMCI controller is configured to receive the SOR-CMCI configuration or SOR information from a network apparatus when the UE is in a NG-RAN cell. Further, the SOR-CMCI controller is configured to initiate a Tsor-cm timer by applying the SOR-CMCI configuration. Further, the SOR-CMCI controller is configured to detect a cell change from a first cell to a second cell. Further, the SOR-CMCI controller is configured to stop apply the SOR-CMCI configuration in response to determining that the UE performs the cell change from the first cell to the second cell, stop the Tsor-cm timer, wherein the first cell is a NG-RAN cell and the second cell is a legacy wireless network cell, and attempt to obtain service on a higher priority PLMN when the UE enters an idle mode or a 5GMM-CONNECTED mode with RRC inactive indication. In another embodiment, the SOR-CMCI controller is configured to continue run the Tsor-cm timer, and on expiry of the Tsor-cm timer perform at least one Tsor-CM-timer expiry action in response to determining that the UE performs cell change from the first cell to the second cell, wherein the first cell is a NG-RAN cell and the second cell is a new NG-RAN cell.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

The embodiments herein achieve a method for handling steering of roaming connected mode control information (SOR-CMCI) configuration during a cell change of a UE. The method includes receiving, by the UE, the SOR-CMCI configuration or SOR information from a network apparatus when the UE is in a NG-RAN cell. Further, the method includes initiating, by the UE, a Tsor-cm timer by applying the SOR-CMCI configuration. Further, the method includes detecting, by the UE, a cell changes from a first cell to a second cell. Further, the method includes performing, by the UE, one of: stop applying the SOR-CMCI configuration in response to determining that the UE performs the cell change from the first cell to the second cell, stopping the Tsor-cm timer, wherein the first cell is a NG-RAN cell and the second cell is a legacy wireless network cell, and attempting to obtain service on a higher priority PLMN when the UE enters an idle mode or a 5GMM-CONNECTED mode with RRC inactive indication, and continue running the Tsor-cm timer, and on expiry of the Tsor-cm timer performing at least one Tsor-CM-timer expiry action in response to determining that the UE performs cell change from the first cell to the second cell, wherein the first cell is a NG-RAN cell and the second cell is a new NG-RAN cell.

In an embodiment, the method can be used to manage the SOR CMCI information when the UE is in different radio access technologies. The UE determines that the UE has received the SOR or the SOR CMCI information. The UE determines that the UE has been configured with the SOR CMCI information, thus UE the starts Tsor-CM timers. In response to determining that the UE has moved to legacy RAT cell (e.g., EPC/3G network/2G network), the UE behaves as if no SOR_CMCI is configured (i.e., stop applying SOR_CMCI configuration), the UE Stop all the running Tsor-CM timers. Further, the UE shall wait for NAS signaling connection release the UE shall wait until it moves to idle mode or 5GMM-CONNECTED mode with RRC inactive indication before attempting to obtain service on a higher priority PLMN by acting as if timer T that controls periodic attempts has expired.

In another embodiment, the method can be used to manage the SOR CMCI information when the UE is in different radio access technologies. The UE determines that the UE has received the SOR or the SOR CMCI information. The UE determines that the UE has been configured with the SOR CMCI information, thus UE the starts Tsor-CM timers. In response to determining that UE is in a 5GS, the UE continue to run the Tsor-CM timer. At expiry of Tsor-CM timer, then the UE will execute a NAS procedure requesting the release of all PDU sessions and resources and move in IDLE mode. Optionally, the NAS procedure to request the release of all the PDU session and resources to move in an IDLE mode is triggered only if and has a list of available and allowable PLMNs in the area and based on this list or any other implementation specific means, the UE determines that there is a higher priority PLMN than the selected VPLMN.

In another embodiment, if the UE selects a cell of any access technology other than NG-RAN, the ongoing SOR procedure is terminated and the UE shall stop applying SOR-CMCI and stop all running Tsor-cm timers without triggering any further actions. The UE shall wait until it moves to idle mode or a 5GMM-CONNECTED mode with RRC inactive indication before attempting to obtain service on a higher priority PLMN by acting as if timer T that controls periodic attempts has expired.

In another embodiment, when the UE determines that no Tsor-cm timer is started for any PDU session or service, the last running Tsor-cm timer is stopped due to release of the associated PDU sessions or stop of the associated services, or the last running Tsor-cm timer expires, if the UE has a list of available and allowable PLMNs or SNPNs in the area and based on this list or any other implementation specific means, the UE determines that there is a higher priority PLMN or SNPN than the selected VPLMN or non-subscribed SNPN.

Further, the UE does not have a list of available and allowable PLMNs or SNPNs in the area and is unable to determine whether there is a higher priority PLMN or SNPN than the selected VPLMN or non-subscribed SNPN using any other implementation specific means; then if the UE is in 5GMM-CONNECTED mode, the UE shall perform the deregistration procedure that releases all the established PDU sessions and services, if any, and once the UE enters idle mode it shall attempt to obtain service on a higher priority PLMN or SNPN by acting as if timer T that controls periodic attempts has expired.

The proposed method can be used to manage the SoR-CMCI timer and the SoR-CMCI configuration.

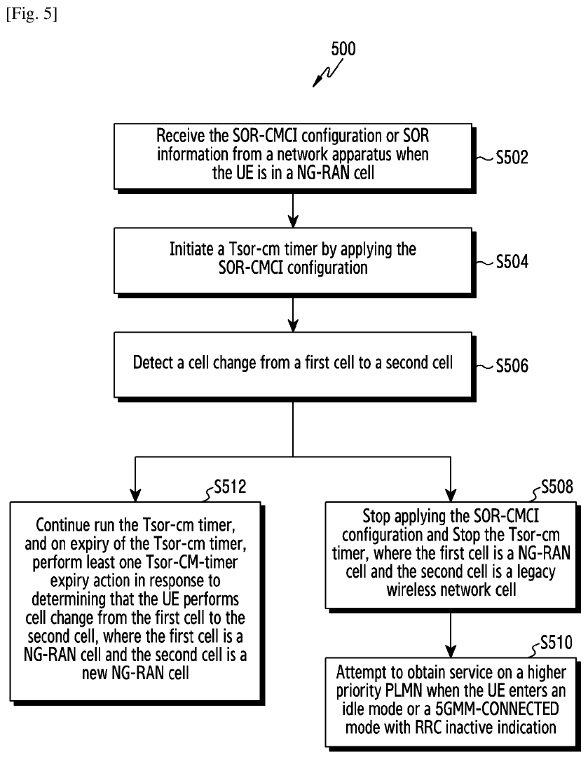

Referring now to the drawings and more particularly to FIGS. 4 to 5 where similar reference characters denote corresponding features consistently throughout the figures, there are shown preferred embodiments.

FIG. 4 illustrates an example of a network structure for processing SOR-CMCI configuration during handover in a wireless communication system according to various embodiments of the present disclosure.

FIG. 4 illustrates an overview a 5th wireless network (1000) for handling SOR-CMCI configuration during a intersystem change procedure or intrasystem change for example handover procedure, according to an embodiment as disclosed herein. In an embodiment, the 5th generation wireless network (1000) or 5G system (5GS) or NG-RAN includes an UE (100) and a network apparatus (500). The UE (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IOT) device.

In this embodiments the terms 5G system (5GS), 5GC (5G core), NG-RAN and 5th generation wireless network are used interchangeably but indicate the same 5th generation wireless network.

Further, the UE (100) includes a processor (110), a communicator (120), a memory (130), and a SOR-CMCI controller (140). The processor (110) is coupled with the communicator (120), the memory (130), and the SOR-CMCI controller (140). The SOR-CMCI controller (140) is configured to receive the SOR-CMCI configuration or SOR information from the network apparatus (500) when the UE (100) is in a NG-RAN cell. Further, the SOR-CMCI controller (140) is configured to initiate a Tsor-cm timer by applying the SOR-CMCI configuration. Further, the SOR-CMCI controller (140) is configured to detect a cell change from a first cell to a second cell. The cell change is due to a handover procedure, a redirection procedure, a cell change order a reselection procedure and any other intersystem or intra-system change procedure which makes UE to change the cell.

The processor (110) controls general operations of the core network device. For example, the processor (110) transmits and receives signals through the communicator (120). In addition, the processor (110) invokes and executes a command stored in the memory (130), and records and reads data. For doing so, the processor (110) may include at least one processor. According to various embodiments, the processor (110) may control the core network device to perform operations according to various embodiments to be described.

The communicator (120) provides an interface for communicating with other devices in the network. That is, the communicator (120) converts a bit stream transmitted from the core network device to other device into a physical signal, and converts a physical signal received from other device into a bit stream. That is, the communicator (120) may transmit and receive signals. Accordingly, the communicator (120) may be referred to as a modem, a transmitter, a receiver, or a transceiver. In this case, the communicator (120) enables the core network device to communicate with other devices or systems via a backhaul connection (e.g., wired backhaul or wireless backhaul) or over the network.

The memory (130) stores data such as a basic program, an application program, and setting information for the operation of the core network device. The memory (130) may include a volatile memory, a nonvolatile memory or a combination of a volatile memory and a nonvolatile memory. In addition, the memory (130) provides the stored data at a request of the processor (110). Further, the SOR-CMCI controller (140) is configured to stop apply the SOR-CMCI configuration in response to determining that the UE (100) performs the cell change from the first cell to the second cell and stop the Tsor-cm timer, where the first cell is a NG-RAN cell and the second cell is a legacy wireless network cell. The legacy wireless network cell can be, for example, but not limited to an UTRAN cell, an E-UTRAN cell, and a GERAN cell. Further, the SOR-CMCI controller (140) is configured to attempt to obtain service on a higher priority PLMN when the UE (100) enters an idle mode or a 5GMM-CONNECTED mode with RRC inactive indication.

In another embodiment, Further, the SOR-CMCI controller (140) is configured to continue run the Tsor-cm timer, and on expiry of the Tsor-cm timer perform at least one Tsor-CM-timer expiry action in response to determining that the UE (100) performs cell change from the first cell to the second cell, wherein the first cell is a NG-RAN cell and the second cell is a new NG-RAN cell.

The Tsor-CM-timer expiry action can be, for example, but not limited to determine to perform a PLMN selection, determine that the UE (100) is in a connected state, perform a NAS procedure comprising deregistration procedure requesting release of all PDU sessions and services, determine that the UE (100) enters in an IDLE mode, and attempt to obtain service on a higher priority PLMN by performing PLMN selection procedure. The PLMN selection is determined based on at least one of determining by the UE (100) that there is a higher priority PLMN than selected VPLMN (200) in response to determining that the list of available and the allowable PLMNs in the area is available at the UE (100), and inability of the UE (100) to determine a higher priority PLMN than selected VPLMN (200) in response to determining that the list of available and the allowable PLMNs in the area is not available.

In an embodiment, when the timer Tsor-cm stops or expires, while the UE (100) is in a dual registered mode, if the UE (100) has a list of available and allowable PLMNs in the area and based on this list or any other implementation specific means, the SOR-CMCI controller (140) determines that there is a higher priority PLMN than the selected VPLMN (200), then the SOR-CMCI controller (140) shall perform the NAS procedure (e.g. deregistration/detach procedure) in both (or one of) the 5GS (300) and the EPS (400) that releases all the established PDU and PDN sessions and the UE (100) enters idle mode on both (or one of) the RATs and attempts to obtain service on a higher priority PLMN, by acting as if the timer T that controls periodic attempts has expired.

In an embodiment, while the UE (100) is in the dual registered mode, the timer Tsor-cm stops, when the associated PDU or PDN session(s) is released or the associated service is stopped. If the value for timer Tsor-cm was selected as the highest among other values included in SOR-CMCI then the timer Tsor-cm stops when the associated PDU or PDN session(s) for that timer value is released or the associated service is stopped. If the UE (100) enters idle mode or 5GMM-CONNECTED mode with RRC inactive indication while the timer Tsor-cm is running, then the SOR-CMCI controller (140) stops the timer.

While the UE (100) moves from the dual registered mode to the single registered mode (either in 5GC (300) or EPC (400)) or vice versa no change in Tsor-cm timer is required; i.e., the timer will keep running until expiry and on expiry or on stoppage of Tsor-cm timer, the Tsor-cm timer expiry actions are executed.

In an embodiment, the Tsor-cm timer may keep running, while the UE (100) is in the dual registered mode. After the Tsor timer expiry, the UE (100) ignores the Tsor timer expiry; i.e., no action will be taken, if the UE (100) is in the dual registered mode. If the UE (100) moves from the dual registered mode to single registered mode and registers only over the 5GC (300) below actions may be performed based on the following conditions:

The UE (100) registers only over the 5GC (300) and Tsor-cm timer running.

1. The timer Tsor-cm stops when the associated PDU or PDN session(s) is released or the associated service is stopped. If the value for timer Tsor-cm was selected as the highest among other values included in SOR-CMCI, then the timer Tsor-cm stops when the associated PDU or PDN session(s) for that timer value is release or the associated service is stopped. If the UE (100) enters the idle mode or the 5GMM-CONNECTED mode with the RRC inactive indication (refer 3GPP TS 24.501), while timer Tsor-cm is running, then the UE (100) stops the timer.

2. The UE (100) registers only over the 5GC (300) and Tsor-cm timer expired after moving to single registered mode.

3. The UE (100) registers only over the 5GC (300) and Tsor-cm timer already expired while the UE (100) is in the dual registered mode:

4. If the UE (100) has a list of available and allowable PLMNs in the area and based on this list or any other implementation specific means, the UE (100) determines that there is the higher priority PLMN than the selected VPLMN (200), then the UE (100) shall perform the NAS procedure for e.g. deregistration procedure that releases all the established PDU sessions and the UE (100) enters the idle mode and attempts to obtain service on the higher priority PLMN by acting as if timer T that controls periodic attempts has expired.

If the UE (100) registers over the EPC (400) and the Tsor-cm timer is expired then, no action may be taken.

Further, the Tsor-cm timer may be stopped, while the UE (100) moves to the dual registered mode from the single registered mode, if Tsor-cm timer was already running. Tsor-cm timer may not start, if the UE (100) is in the dual registered mode and 5GC (300) has provided SoR information or SoR-CMCI timer information. The Tsor-cm timer will only start if the UE moves from dual registered mode to single registered mode.

The UE (100) can be used for handling the SoR-CMCI timer in the EPC (400) or other legacy networks using following steps.

Step A: When the timer Tsor-cm stops or expires, while the UE (100) is in the EPC (400) or other legacy networks (e.g. 3G, 2G etc), if the UE (100) is in the connected state and has a list of available and allowable PLMNs in the area and based on this list or any other implementation specific means, the UE (100) determines that there is a higher priority PLMN than the selected VPLMN (200), then the UE (100) shall perform the NAS procedure (e.g., deregistration procedure) that releases all the established PDN sessions and the UE (100) enters idle mode and attempts to obtain service on the higher priority PLMN, by acting as if timer T that controls periodic attempts has expired.

Step B: While the UE (100) is registered in the EPC (400) or other legacy networks (e.g., 3G, 2G etc), the timer Tsor-cm stops, when the associated PDN session(s) (also called as PDN connections in this embodiment) is released or the associated service is stopped. If the value for timer Tsor-cm was selected as the highest among other values included in SOR-CMCI, then the timer Tsor-cm stops, when the associated PDN session(s) for that timer value is release or the associated service is stopped. If the UE (100) enters into idle mode, while timer Tsor-cm is running, then the UE (100) stops the timer.

When the UE (100) is handed over from the 5GC (300) to the EPC (400) (or vice versa) (or optionally also to EPC (400) to or other legacy networks (e.g., 3G, 2G etc)) while in 5GC Tsor-cm timer was running, the Tsor-cm timer will keep running until expired and on expiry or on stoppage of Tsor-cm timer conditions are met. The UE (100), if in the connected mode, will execute the NAS procedure requesting the release of all PDU sessions and resources and move in IDLE mode. Optionally, the UE (100) executes this step, if the UE (100) is able to map the services (against which the Tsor-CM timer(s) is running) of 5GS in EPS either by the UE implementation or with the help of the network (i.e., the network may have configured, in the UE (100), the mapping between the services in 5GS to EPS or vice versa).

When the ME receives USAT refresh command with SOR information (i.e., OPLMN list)/SOR_CMCI while in the EPC (400) or other legacy networks (e.g., 3G, 2G etc), the UE (100) may decide to start Tsor-cm timer of 5GS. The Tsor-cm timer will keep running until expired and on expiry or on stoppage of Tsor-cm timer, the Tsor-cm timer expiry actions are executed. Optionally, the UE (100) executes this step, if the UE (100) is able to map the services (against which the Tsor-CM timer(s) is running) of 5GS in EPS either by the UE implementation or with the help of the network (i.e., the network may have configured, in the UE, the mapping between the services in 5GS to EPS or vice versa).

When the UE (100) is handed over from the 5GC (300) to the EPC (400) (or vice versa) (or optionally also to EPC to or other legacy networks (e.g., 3G, 2G etc.)), while in 5GC Tsor-cm timer was running, the Tsor-cm timer(s) shall be stopped, optionally this step of stopping the Tsor-cm timer (that is not applying the SOR-CMCI configuration) is performed only if the UE is in the single registration mode, and the UE (100) shall wait for the release of the NAS signalling connection, before attempting to obtain service on a higher priority PLMN, as specified in TS 23.122 sub-clause 4.4.3.3, by acting as if timer T that controls periodic attempts has expired.

When the UE (100) is handed over from the 5GC (300) to the EPC (400) (or vice versa) (or optionally also to the EPC (400) to or other legacy networks (e.g., 3G, 2G etc.)) while in 5GC Tsor-cm timer was running, the Tsor-cm timer can be restarted (i.e. stopped and started again) with initial assigned value and on expiry or on stoppage of Tsor-cm timer conditions are met. The UE (100), if in connected mode, will execute the NAS procedure requesting the release of all PDU sessions and resources and move into IDLE mode as described in step A.

The Tsor timer continues to run when there is a RAT change from 5GS to EPS or vice versa. If the timer Tsor expires or stopped and if the:
1. The UE (100) is in the EPS, then the UE (100) shall wait for the release of the NAS signalling connection, before attempting to obtain service on a higher priority PLMN, as specified in TS 23.122 sub-clause 4.4.3.3, by acting as if timer T that controls periodic attempts has expired.
2. The UE (100) is in the 5GS, then the UE (100) will execute a NAS procedure requesting the release of all PDU sessions and resources and move in IDLE mode. Optionally, the NAS procedure to request the release of all the PDU session and resources to move in IDLE mode is triggered only if and has a list of available and allowable PLMNs in the area and based on this list or any other implementation specific means, the UE determines that there is a higher priority PLMN than the selected VPLMN (200).

In this embodiment, wherever it is specified to send a NAS message to request the release of the NAS signalling connection is specified, the UE (100) alternatively can choose to do local signalling connection release without peer to peer signalling with the network and take next steps like to attempt registration on higher priority PLMN as specified in relevant section.

In an embodiment disclosed, wherever the steps: the NAS procedure to request the release of all the PDU session and resources to move in IDLE mode is specified it can be executed only if the UE has a list of available and allowable PLMNs in the area and based on this list or any other implementation specific means, the UE determines that there is a higher priority PLMN than the selected VPLMN (200).

In an embodiment, there should be default Tsor-cm timer configured in the UE (either in ME or USIM) which can be pre-configured in the UE or sent over NAS signalling message or data transport or any other means of transport by network (HPLMN/VPLMN). If the SOR-CMCI configuration is not available at the UE, the default Tsor-cm timer will start as soon, as the UE (100) receives SoR information or OPLMN list from the network, while on VPLMN (200).

The default Tsor-cm timer may run in all legacy core networks (i.e., EPC, 3G, 2G, etc). On expiry of the Default Tsor-cm timer, if the UE is in connected state and has a list of available and allowable PLMNs in the area and based on this list or any other implementation specific means, the UE determines that there is a higher priority PLMN than the selected VPLMN (200), then the UE shall perform the NAS procedure (e.g. deregistration procedure) (see clause 4.2.2.3 of 3GPP TS 23.502) that releases all the established PDN/PDU sessions and the UE enters idle mode and attempts to obtain service on a higher priority PLMN, by acting as if the timer T that controls periodic attempts has expired.

If the UE (100) receives SoR-CMCI configuration while Tsor-cm timer was running:
1. The UE (100) may start Tsor-cm timer and stop default timer; or
2. The UE (100) may start Tsor-cm timer with the elapsed value of default timer; e.g., if Tsor-cm timer received from network is for 5 minutes and default timer already ran for 2 mins, Tsor-cm timer will run for another 3 minutes (5 minutes-2 minutes i.e., for elapsed time);
3. The UE (100) can run the timer with minimum value between Tsor-CM timer and default timer (or the elapsed time).
4. The UE (100) can run the timer with higher value between Tsor-CM timer and default timer (or the elapsed time).

The SOR-CMCI controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 4 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 5 illustrates an example of a process for processing SOR-CMCI configuration during handover in a wireless communication system according to various embodiments of the present disclosure.

FIG. 5 is a flow chart (S500) illustrating a method for handling SOR-CMCI configuration during the intersystem or intra-system change for example handover procedure, according to an embodiment as disclosed herein. The operations (S502-S514) are performed by the SOR-CMCI controller (140).

At S502, the method includes receiving the SOR-CMCI configuration or the SOR information from the network apparatus (500) when the UE (100) is in the NG-RAN cell i.e., When the UE is in the fifth-generation wireless network. At S504, the method includes initiating the Tsor-cm timer by applying the SOR-CMCI configuration. At S506, the method includes detecting the cell change from the first cell to the second cell.

At S508, the method includes stop applying the SOR-CMCI configuration and stopping the Tsor-cm timer in response to determining that the UE (100) performs the cell change from the first cell to the second cell, where the first cell is the NG-RAN cell and the second cell is the legacy wireless network cell. At S510, the method includes attempt to obtain service on a higher priority PLMN when the UE (100) enters the idle mode or the 5GMM-CONNECTED mode with RRC inactive indication.

At S512, the method includes continue running the Tsor-cm timer, and on expiry of the Tsor-cm timer, and performing Tsor-CM-timer expiry action in response to determining that the UE performs cell change from the first cell to the second cell, where the first cell is a NG-RAN cell and the second cell is a new NG-RAN cell.

The various actions, acts, blocks, steps, or the like in the flow chart (S500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phrascology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

1-14. (canceled)

15. A method performed by a user equipment (UE) in a wireless communication system, the method comprising:
receiving, from an access and mobility management function (AMF) entity, steering of roaming (SoR) information including SoR connected mode control information (CMCI), the SoR CMCI including a value of a timer associated with a release of protocol data unit (PDU) session or a service and entering idle mode; and
applying the SoR CMCI by starting the timer based on the value,
wherein, in case that the UE selects a second cell associated with a second radio access technology (RAT) different from a first cell associated with a first RAT, the timer is stopped without triggering an action.

16. The method of claim 15, wherein a radio access network associated with the first RAT is a new generation radio access network (NG-RAN), and
wherein a radio access network associated with the second RAT is any other radio access network other than the NG-RAN.

17. The method of claim 16, further comprising:
identifying that the timer is expired, in case that the UE has a list of available and allowable public land mobile networks (PLMNs), and there is a higher priority PLMN than a selected visited PLMN (VPLMN); and
performing a deregistration procedure releasing all established PDU sessions and services.

18. The method of claim 17, further comprising:
entering the idle mode from a connected mode after performing the deregistration procedure; and
obtaining a service on the higher priority PLMN.

19. A user equipment (UE) in a wireless communication system, the UE comprising:
a transceiver; and
a controller coupled with the transceiver and configured to:
receive, from an access and mobility management function (AMF) entity, steering of roaming (SoR) information including SoR connected mode control information (CMCI), the SoR CMCI including a value of a timer associated with a release of protocol data unit (PDU) session or a service and entering idle mode, and
apply the SoR CMCI by starting the timer based on the value,
wherein, in case that the UE selects a second cell associated with a second radio access technology (RAT) different from a first cell associated with a first RAT, the timer is stopped without triggering an action.

20. The UE of claim 19, wherein a radio access network associated with the first RAT is a new generation radio access network (NG-RAN), and
wherein a radio access network associated with the second RAT is any other radio access network other than the NG-RAN.

21. The UE of claim 20, wherein the controller is further configured to:
identify that the timer is expired, in case that the UE has a list of available and allowable public land mobile networks (PLMNs), and there is a higher priority PLMN than a selected visited PLMN (VPLMN), and
perform a deregistration procedure releasing all established PDU sessions and services.

22. The UE of claim 21, wherein the controller is further configured to:
enter the idle mode from a connected mode after performing the deregistration procedure, and
obtain a service on the higher priority PLMN.
